(19) United States
(12) Patent Application Publication
(10) Pub. No.: US 2002/0068152 A1
(43) Pub. Date: Jun. 6, 2002

(54) Thermal comfort liner for helmets

(76) Inventors: Cleveland A. Heath, Medfield, MA (US); Suzanne M. Reeps, Acton, MA (US); Walter B. Teal JR., Shrewsbury, MA (US)

Correspondence Address: Office of Counsel, Bldg 112T, Naval Undersea Warfare Center, Division, Newport, 1176 Howell Street, Newport, RI, 02841-1708, US

(21) Appl. No.: 09/729,629

(22) Filed: Dec. 4, 2000

(51) Int. Cl. B32B 3/12

(52) U.S. Cl. 428/178

(57) ABSTRACT

A comfort liner including a sealing layer of material, a plurality of bubble members formed on the sealing layer of material, and a thermal material formed within each of the plurality of bubble members. The thermal material is a heat absorbing material whose absorption of heat will provide cooling within a range of at least 70 degrees F. to 85 degrees F.

### STATEMENT OF GOVERNMENT INTEREST

The invention described herein may be manufactured and used by or for the Government of the United States of America for governmental purposes without the payment of any royalties thereon or therefor.

### BACKGROUND OF THE INVENTION

(1) Field of the Invention

This invention generally relates to a thermal comfort liner for helmets. More particularly, the invention relates to a thermal comfort liner for helmets in which a paraffin phase change material is incorporated into dimpled protrusions of a helmet liner.

(2) Description of the Prior Art

The current art for helmet liners is evident in the equipment used by military aviators who wear a flight helmet during pre-flight, in-flight, and post flight operations. This helmet often induces heat stress in the head region, especially during warm weather or periods of medium to high physical activity. The problem is exacerbated by the need to wear various protective garments such as chemical/biological defense clothing, anti-exposure suits, anti-G garments, and the like. This heat stress is generally evidenced by feelings of discomfort, redness of the skin, and sweat production. The sweat production causes other problems such as fogging of eye glasses or stinging in the eyes that may result in impaired aviator performance. If a method can be found to reduce the level of heat stress from wearing the helmet, the aviators will be more comfortable, resulting in less distraction from their tasks at hand, and improving their overall performance.

Thus, a problem exists in the art whereby there is no existing helmet which will sufficiently accommodate a wearer throughout an entire range of helmet uses.

The following patents, for example, disclose various types of helmet liners, but do not disclose a long term use helmet as described in the instant invention which is comfortable and useful over a wide range of temperatures and an extended period of time, and which may be reused. Still further, the cited patents focus on various methods for applying a cooling material, and not on the identity of the coolant itself. Of course, selecting the correct coolant is critical to the efficacy of any cooling device. All of the cited patents fail to specify an appropriate coolant with the following exceptions. Only two (2) specific materials are identified in any of the prior art. These material are ice and Freon. The Freon is not a cooling device at all, but rather uses saturated Freon as protection from impact. Ice will absorb large quantities of heat as it melts, however, ice begins to melt at 32 degrees F., too cold for providing comfortable cooling to the human body. Additionally, once melted, water will require a freezer to be regenerated to ice for the next cooling cycle.

U.S. Pat. No. 4,133,055 to Zebuhr;

U.S. Pat. No. 4,776,042 to Hanson et al.;

U.S. Pat. No. 4,853,908 to Zarotti;

U.S. Pat. No. 5,054,122 to Sher;

U.S. Pat. No. 5,327,585 to Karlan; and

U.S. Pat. No. 5,557,807 to Hujar et al.

More specifically, Zebuhr discloses a protective helmet with a thermal liner removably positioned therein, and a container for the freezing and storage of a plurality of such liners. The thermal liner includes a matrix of sufficient length and width which is sufficiently deformable so as to be insertable within a helmet in spaced relation to its inner wall to conform generally with the contour of the inner wall and to be coextensive with the major portion of the inner wall area. The liner is provided with a plurality of pockets in the matrix each of which is sealed relative of the other pockets. A heat exchange medium, preferably in its frozen state such as ice, is disposed within the pockets of the liner.

Hanson et al. discloses a cryokenetic headband having a closable pocket for retaining a cold pack material. The headband is intended to be worn during exercise or work to keep the head cool and perspiration from running into the wearers eyes.

Zarotti discloses a padding element suitable for use in a crash helmet having a plurality of padding elements including a plurality of first deformable blisters interconnected together in sets, and containing a fluid which is in a saturated vapor state when the helmet has been worn for a sufficient time to raise its fluid temperature to a temperature approaching normal body temperature. It is contemplated that the fluid contained in the first deformable blisters preferably includes a mixture of Freon MF and Freon TF with the proportion of Freon MF and Freon TF being in the range of 20% to 50% by volume liquid.

Sher is directed to a structure of a hat with a cooling system for the head, which includes a covering for the head, having a channel holder made on its inner wall surface for the fastening therein of a plurality of cooling elements and a flexible, ventilating socket. The cooling elements absorb heat when the hat is put on the head, so as to cool and comfort the head. The cooling elements are made of chemicals to absorb heat from the surface of an object so as to greatly reduce the surface temperature of an object. The cooling elements are positioned between the ventilating socket and the channel holder so that the ventilating socket is in contact with the wearer's head.

Karlan discloses an elongated, semi-flat tubular body constructed of flexible fluid impervious material. The tubular body is divided into separate longitudinally spaced compartments along longitudinally spaced flexible transverse zones of the body. The compartments are filled with a fluid eutectic solution and the body may be folded along the transverse zones for relative annular displacement of the adjacent compartments. The elongated, semi-flat tubular body may be removably supported within the channel defined by the sweat band of a hat or cap and may be used to absorb heat from the adjacent head areas of the wearer of the hat or to provide heat to those adjacent head areas.

Hujar et al. discloses an article of headwear for covering the head, including coolant means for cooling the head of the wearer, and more particularly, cooling means which provide a prolonged cooling effect. The coolant means is contained in one or more pouches comprised of two layers of different material, the first or outer material being a thin material having good thermal transmissive properties and preferably also having some water resistant properties, and the second or inner material provided interior of the first material and having thermal insulative properties. These layers, used in combination, have an effect of absorbing heat from the head of the wearer without at the same time absorbing excessive heat from the environment, and thus provide a sustained cooling effect. A heat releasing means can be substituted in place of the coolant means when it is desired to warm the head of the wearer.

It should be understood that the present invention would in fact enhance the functionality of the above patents by providing a simple, inexpensive and useful thermal comfort liner for a helmet.

### SUMMARY OF THE INVENTION

Therefore it is an object of this invention to provide a thermal comfort liner for a helmet in which is formed within an existing helmet liner.

Another object of this invention is to provide a thermal comfort liner having a plurality of dimpled regions.

Still another object of this invention is to provide a thermal comfort liner having a plurality of dimpled regions in which the dimpled portions contain a paraffin phase change material.

A still further object of the invention is to provide a thermal comfort liner having multiple layers of dimpled liners, each dimple containing a paraffin phase change material.

Yet another object of this invention is to provide a thermal comfort liner which is simple to manufacture and easy to use.

In accordance with one aspect of this invention, there is provided a comfort liner including a sealing layer of material, a plurality of bubble members formed on the sealing layer of material, and a thermal material formed within each of the plurality of bubble members. The thermal material is a heat absorbing material whose absorption of heat will provide cooling within a range of at least 70 F. to 85 F.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a side perspective view of a helmet liner according to a first preferred embodiment of the present invention;

FIG. 2 is a side view of a portion of the first preferred embodiment of the present invention; and

FIG. 3 is a side view of another preferred embodiment of the present invention

### DESCRIPTION OF THE PREFERRED EMBODIMENT

In general, the present invention is directed to a comfort liner for helmets such that thermal comfort is provided to the persons wearing the helmet.

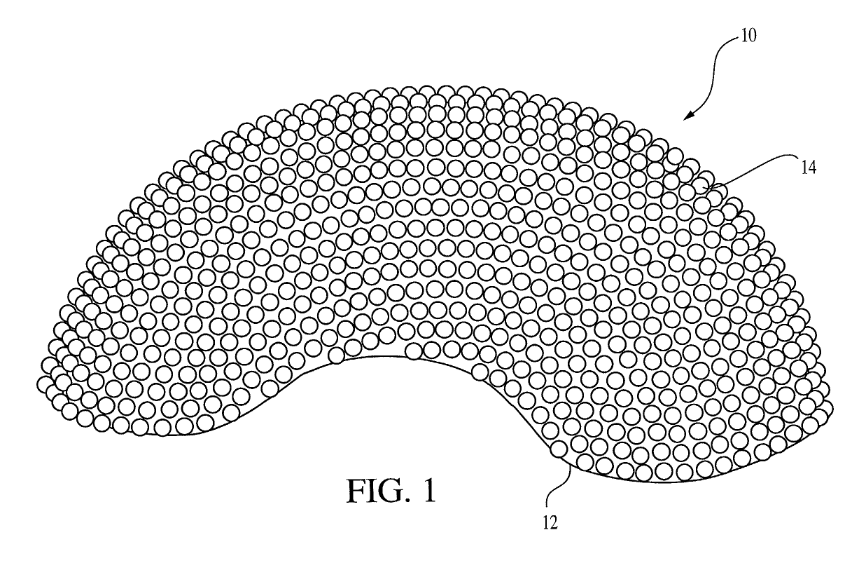

Referring first to FIG. 1, there is shown a perspective view of a thermal comfort liner 10 according to a first preferred embodiment of the present invention. In general, the thermal comfort liner 10 is a flexible and formable type of liner which may be inserted into any number of types of helmets where the object of the liner is to impart thermal comfort as well as safety to the wearer.

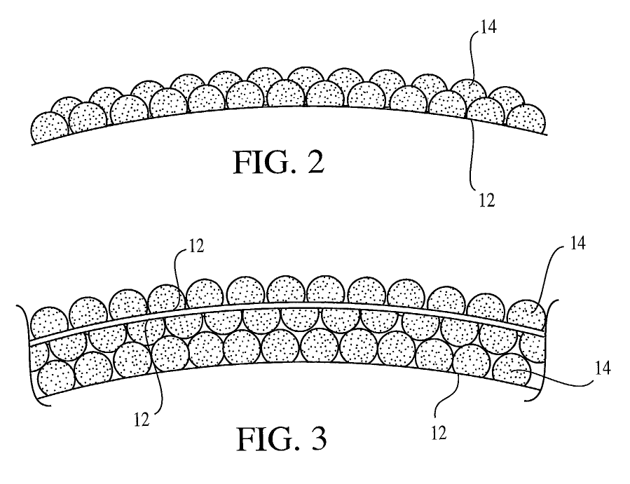

FIG. 2 is a side view showing a single layer of the thermal comfort liner 10. A single layer of the thermal comfort liner 10 includes a sealing layer 12 and a plurality of bubble members or dimples 14 formed on the sealing layer 12 as shown. The plurality of bubble members 14 are evenly spaced over the sealing layer and may be formed as any suitable pattern according to an end use of the liner 10.

Distinctive to the present invention is the use of a paraffin phase change material coolant, which is superior to other coolants for head cooling, and integration of the device to contain the cooling medium within the existing helmet liner.

The first innovation involves the use a paraffin phase change material coolant, which is superior to other coolants for head cooling. The ideal material for cooling a head will have three fundamental characteristics: the ability to absorb large quantities of heat (i.e., provide a lot of cooling), to provide the cooling at a temperature that is comfortable for the head, and possess the ability to be regenerated easily.

Paraffin phase change materials absorb large quantities of heat as they change from a solid to a liquid, but they absorb this heat at temperatures that are much more comfortable than ice for the human body, and are much easier to regenerate. Several paraffin materials are available that change phase (and hence, absorb heat) at temperatures ranging from 65 degrees F. to 85 degrees F. While paraffin phase change materials are available that will melt at temperatures above and below this range, it is the inventors' discovery that this temperature range is best suited for providing cooling to the human body. Regeneration of paraffin phase change materials is easier than regenerating ice. In general, a paraffin may be regenerated in any air-conditioned space, such as the changing room where pilots typically store their flight gear. As long as the room temperature is below the temperature (e.g., 70 degrees F.) at which the paraffin changes phase, it will regenerate without the need for a freezer. Thus, the invention is novel and superior in that the inventors have identified superior cooling materials (the paraffin phase change materials) not understood heretofore in the art.

Integration of the cooling medium within the helmet liner 10 is by use of the bubbles 14 as described. The known art only utilize pouches, liners, or headbands (containing a coolant) which must be added to various types of headgear. In every case, the method of applying cooling requires the addition of a new item (pouch, liner, etc.) to the headgear. The novelty of the present invention is that the coolant is integrated into an existing liner, it does not require that addition of a new liner, or pouch, or headband. Instead, the invention uses a liner that is already present in the helmet. The helmet worn by aviators has a liner of five layers of dimpled plastic. The purpose of this liner is to allow the aviator to “custom fit” the helmet. The aviator removes one or more layers of the dimpled plastic liner in order to obtain the desired fit. The present invention seals the coolant in the existing dimples 14 of this plastic liner 10. The invention does not require the addition of a new liner. The ability to integrate the coolant into the existing liner 10 is critical to the application of cooling to aviator's helmets. An ill-fitting helmet is potentially disastrous in high performance aircraft. Under the high gravitational forces experienced by aviators, an imperfect fit will cause the helmet to slip on the aviator's head, resulting in impaired vision, and all of the associated disasters that could occur as a result. The approach used by other helmets, adding pouches, headbands, or liners will change the fit of the aviator's helmet, making it too tight. To remedy this, an aviator is likely to remove an additional layer of the dimpled plastic “fit” liner. However, when the aviator later wore the helmet without the cooling device (pouch, headband, etc.), the helmet would no longer fit properly, potentially creating the hazard described above. The novelty of the present invention is that the coolant is integrated into the existing fit liner, and will not change the way in which the helmet fits on the aviator's head, thus avoiding the potential hazard created by the known art.

The Naval aviator's helmet includes a multi-layered, dimpled plastic liner 10 (shown in FIG. 3) that serves to enhance fit of the helmet. One or more layers of the plastic liner may be removed in order to improve the overall fit. The present invention proposes that a heat absorbing material be sealed in the dimples 14 of the plastic liner 10 to reduce the amount of thermal discomfort experienced by the aviator.

Referring more specifically to FIG. 3, the layers of the thermal comfort liner 10 are arranged such that dimples 14 of a second layer are faced against the dimples 14 of a first layer. Additional layering is such that a sealing layer 12 of the third layer faces a sealing layer of the second layer. The ordering of layers is not intended to be exclusive and is set forth by way of example only.

The heat absorbing material is a paraffin phase change material that absorbs thermal energy at a temperature that provides cooling to the head. The phase change material is sealed into the dimples 14 of each layer of the plastic liner in the helmet. When the aviator dons the helmet, excess heat from the aviator's head will be absorbed by the phase change material as it changes from a solid to a liquid (latent heat of fusion). This absorption will provide cooling to the aviator, reducing or eliminating heat stress in the head region, and improving thermal comfort. The phase change material itself, once liquified, will remain trapped in the sealed dimples of the plastic liner. When the helmet is removed, the phase change material will be cooled by the ambient air, give off the heat that had been previously absorbed, and return to its solidified state in preparation for the next use of the helmet.

The advantages of this invention include improved thermal comfort for aviators, reduced discomfort due to heat stress, reduced skin redness, reduced sweat production in the head region, less fogging of eye glasses, less chance for sweat to get into and sting the aviator's eyes, and most importantly, improved aviator performance.

Heat absorbing materials other than paraffin phase change materials may be used in this application. For example, polyethylene glycol (of the correct molecular weight) may be used, and various salts which change phase at the correct temperature can be used. In addition, some materials, such as certain salt compounds, undergo a water desorption reaction that absorbs heat (heat of adsorption, or heat of absorption) and may be used to provide cooling in this application. Various materials which undergo endothermic reactions may also be used. Liner designs that entrap the heat absorbing material in pockets of shapes other than the current dimples may also be used and are included within the scope of the invention.

It is anticipated that the invention herein will have far reaching applications other than those of aircraft.

This invention has been disclosed in terms of certain embodiments. It will be apparent that many modifications can be made to the disclosed apparatus without departing from the invention. Therefore, it is the intent of the appended claims to cover all such variations and modifications as come within the true spirit and scope of this invention.

What is claimed is:

1. A comfort liner comprising:
a sealing layer of material;
a plurality of bubble members formed on said sealing layer of material; and
a heat exchange material formed within each of said plurality of bubble members.

2. The comfort liner according to claim 1 wherein said heat exchange material is a heat absorbing material whose absorption of heat will provide cooling within a range of at least 70 degrees F. to 85 degrees F.

3. The comfort liner according to claim 2 wherein said cooling material is a paraffin phase change material.

4. The comfort liner according to claim 1 wherein at least one cooling liner forms a cooling barrier.

5. The comfort liner according to claim 1 wherein the sealing layer of material is formed of a flexible material.

6. The comfort liner according to claim 1 wherein each of said plurality of bubbles is formed of a resilient material.

7. The comfort liner according to claim 1 wherein said sealing layer of material and said plurality of bubbles are integrally formed.

8. The comfort liner according to claim 1 wherein said sealing layer of material and said plurality of bubbles are formed as one piece.

9. A cooling liner for a safety helmet comprising:
at least one sealing layer of material;
a plurality of bubble members formed on each said sealing layer of material; and
a cooling material formed within each of said plurality of bubble members.

10. The cooling liner according to claim 9 wherein a plurality of sealing layers of material line an inner surface of said safety helmet.

11. The cooling liner according to claim 9 wherein said plurality of bubble members are formed of a resilient material.

12. The cooling liner according to claim 9 wherein said plurality of bubble members are integrally formed with said sealing layer.

13. The cooling liner according to claim 9 wherein said plurality of bubble members are formed as one piece with said sealing layer.

14. The cooling liner according to claim 9 wherein said cooling liner material is a heat absorbing material.

15. The cooling liner according to claim 14 wherein said heat absorbing material is a paraffin phase change material.

16. The cooling liner according to claim 9 wherein said heat absorbing material is a paraffin phase change material.

17. The cooling liner according to claim 9 wherein said liner is a heat absorbing material whose absorption of heat provides cooling within a range of at least 70 degrees F. to 85 degrees F.

18. A heat exchanging material for a dimpled helmet liner comprising:
a paraffin phase change material formed in said dimples.
